(19) United States
(12) Patent Application Publication
(10) Pub. No.: US 2001/0020267 A1
(43) Pub. Date: Sep. 6, 2001

(54) Pipeline processing apparatus with improved efficiency of branch prediction, and method therefor

(75) Inventor: Seiji Koino, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/796,538

(22) Filed: Mar. 2, 2001

(30) Foreign Application Priority Data
Mar. 2, 2000 (JP) P2000-56959

(51) Int. Cl. G06F 9/00

(52) U.S. Cl. 712/239

(57) ABSTRACT

The present invention provides an apparatus and a method for increasing the branch prediction efficiency of a condition branch instruction and decreasing the instruction execution time in a pipeline processing. This branch prediction apparatus predicts whether a branch condition of a conditional branch instruction is satisfied or non-satisfied based on a branch prediction status, and instructs that a branch destination address is selected as an instruction fetch address when it has been predicted that the branch condition of the condition branch instruction is satisfied, while the branch prediction apparatus decides whether a branch prediction executed according to a result of a decision on the branch condition is correct or wrong at the time of the execution of the conditional branch instruction and instructs that an address of the instruction to be executed next to the condition branch instruction is selected as the instruction fetch address when it has been decided that the branch prediction is wrong. The branch prediction apparatus updates the stored branch prediction status based on a result of a decision on the branch condition, selects the updated latest branch prediction status, and bypass supplies the latest branch prediction status to the succeeding conditional branch instruction that is the same as the preceding conditional branch instruction.

### CROSS-REFERENCE TO RELATED APPLICATION

This application is based upon and claims the benefit of priority from the prior Japanese Patent Application No. 2000-56959, filed Mar. 2, 2000; the entire contents of which are incorporated herein by reference.

### BACKGROUND OF THE INVENTION

1. Field of the Invention

The present invention relates to a pipeline processing apparatus with improved efficiency of branch prediction, and a method therefor. Particularly, the invention relates to a technique for improving the efficiency of branch predict ion in a processor that carries out a pipeline operation.

2. Description of the Related Art

Conventionally, in a pipeline operating processor, an instruction has been read in advance from a branch destination address by branching based on a branch prediction, thereby filling the gap of the pipeline operation following a branch operation. Improvement in the throughput has been realized based o n this method.

FIG. 1 is a diagram showing a structure of a microprocessor including a conventional branch prediction apparatus for carrying out a branch prediction. The processor shown in FIG. 1 executes instructions by employing a pipeline system of six stages, for example. In FIG. 1, the structures of devices correspond to pipeline stages of a stage I, a stage Q, a stage U/R, a stage A, a stage D, and a stage W, respectively.

FIG. 2 is a diagram showing a shift of a status of a branch prediction algorithm in the branch prediction apparatus shown in FIG. 1.

FIG. 2 shows four branch prediction statuses in two bits, including a strong branch non-established status (Strongly Not Taken: SNT), a weak branch non-established status (Weakly Not Taken: WNT), a weak branch established status (Weakly Taken: WT), and a strong branch established status (Strongly Taken: ST). Each prediction status shifts based on a branch establishment or a branch non-establishment, or the prediction status is maintained. In the prediction statuses of the Strongly Not Taken and the Weakly Not Taken, a branch non-establishment is predicted. On the other hand, in the prediction statuses of the Weakly Taken and the Strongly Taken, a branch establishment is predicted. According to this prediction algorithm, the next branch establishment/non-establishment is predicted based on the branch establishment/non-establishment of the past two times.

In FIG. 1, the microprocessor including the branch prediction apparatus comprising a fetch address selector 1 for selecting a fetch address, a program counter 2, an instruction cache 3 for storing an instruction to be executed, a branch prediction status memory unit 4 for storing a branch prediction status corresponding to all condition branch instructions stored in the instruction cache 3, and for carrying out a reading linked with the instruction cache 3, a branch destination address calculation unit 5 for calculating a branch destination address based on a given branch instruction, an instruction decoder and register fetch section 6 for decoding an instruction read from the instruction cache 3, and for fetching a register, a branch prediction execution unit 7 for executing a branch prediction based on a branch prediction status, a branch destination address memory unit 8 for storing a branch destination address that has been calculated by the branch destination address calculation unit 5, a comparator 9 for deciding a branch condition of a branch instruction, a branch prediction deciding unit 10 for deciding a branch prediction based on a result of a branch prediction and a branch condition, a branch prediction status/result holding unit 11 for holding a branch prediction status and a branch prediction result, a program counter holding unit 12 for holding a value of the program counter 2, and a branch prediction status updating unit 13 for updating memory contents of the branch prediction status memory unit 4. This microprocessor executes instructions by the pipeline at six stages, for example, including the stage I, the stage Q, the stage U/R, the stage A, the stage D, and the stage W.

In the above structure, first at the stage I, a value of the program counter 2 as an address for fetching the next instruction is selected. At the next stage Q, an instruction is fetched from the instruction cache 3 according to the address selected at the stage I, and, at the same time, a memory element of the branch prediction status memory unit 4 corresponding to this address is read out.

The instruction that has been read from the instruction cache 3 is decoded and a register is fetched at the next cycle of the stage R, when the instruction decoder is free. On the other hand, when the instruction decoder is not free, the read instruction is stored in an instruction standby buffer 14, and this instruction is in a temporarily waiting status until when the instruction decoder 6 becomes free. This status is at the stage U.

At the next stage A, a source data read out from the register at the stage R and a bypass data of a processing result of a prior instruction are selected. The instruction is sent out to a suitable processing unit, and this instruction is processed according to a result of the decoding at the stage R.

Next, the processing flow of the condition branch instruction in the microprocessor shown in FIG. 1 will be explained. When the instruction to be executed is a conditional branch instruction, a branch destination address offset that has been cut out from the instruction read from the instruction cache 3 at the stage Q is sent to the branch destination address calculation unit 5 from the instruction standby buffer 14 at the next cycle. The branch destination address calculation unit 5 calculates the branch destination address from the address of the conditional branch instruction itself. At the same time, the branch prediction execution unit 7 predicts the satisfaction/non-satisfaction of the branch condition according to the branch prediction status read from the branch prediction status memory unit 4. When the condition satisfaction has been predicted, the prediction execution unit 7 instructs the fetch address selector 1 to select the calculated branch destination address as the next instruction fetch address at the stage I.

On the other hand, when an effective branch prediction status corresponding to the conditional branch instruction has not been stored in the branch prediction status memory unit 4, or when the condition non-satisfaction has been predicted, the branch prediction execution unit 7 does not instruct the fetch address selector 1 regarding the address selection.

In any case, while an effective conditional branch instruction exists at the stages U, R, and A, the value of the program counter 2, the branch destination address, and the branch prediction status used for the prediction are held corresponding to the instruction on the pipeline, in the program counter holding unit 12, the branch destination address memory unit 8, and the branch prediction status/result holding unit 11 respectively, for the recovery of an instruction string to be executed from a branch prediction error and for the updating of the branch prediction status.

At the stage A, the comparator 9 decides a branch condition. The branch prediction deciding unit 10 compares the decision result with the branch prediction result. When both coincide with each other, the branch prediction is hit, and the current pipeline processing can be progressed without interference. On the other hand, when both do not coincide with each other, a branch prediction miss occurs, and the succeeding instruction string of the pipeline is cancelled at this stage. It is necessary to fetch the instruction again according to a correct branch condition.

When a prediction miss has occurred based on a prediction of a condition satisfaction, the fetch address selector 1 at the stage I is instructed to select the address of the instruction next to the branch instruction stored in the program counter holding unit 12. On the other hand, when a prediction miss has occurred based on a prediction of a condition non-satisfaction, the fetch address selector 1 at the stage I is instructed to select the branch destination address stored in the branch destination address memory unit 8.

Regardless of whether the branch prediction has been a hit or an miss, at the stage D, the branch prediction status updating unit 13 generates a new branch prediction status to be written back to the branch prediction status memory unit 4 from the branch condition decision result and the branch prediction status held in the branch prediction status/result holding unit 11, according to the shift diagram shown in FIG. 2. At the last stage W, the updated branch prediction status is written back to the memory elements of the branch prediction status memory unit 4 corresponding to the address of the branch instruction held in the program counter holding unit 12.

Next, the operation of the conditional branch instruction will be explained with reference to the flow of the pipeline operation shown in FIG. 3. FIG. 3A shows an operation of the processor in a branch non-establishment prediction miss, or having no branch prediction function. FIG. 3B shows the operation of a branch establishment prediction hit. FIG. 3C shows one example of an operation of a program loop in which a branch destination instruction of a branch instruction is the branch instruction itself.

In FIG. 3A, in the cycle 0, the address of the branch instruction is selected as the fetch address at the stage I. In the cycle 1, the branch prediction status of the branch instruction is read from the branch prediction status memory unit 4 at the stage Q. At the same time, the address of (the branch instruction+1) is selected as a fetch address at the stage I. In the cycle 2, the branch prediction is carried out at the stage R. However, because of a branch non-establishment prediction, the address of (the branch instruction+2) is selected as a fetch address at the stage I. In the cycle 3, the branch is established based on a decision of the branch instruction condition, and a branch prediction miss is decided at the stage A. The branch destination address of the branch instruction is selected as a fetch address at the stage I, and the instructions at the stage Q and the stage R are cancelled. In this case, a bubble of two cycles (that is, a state that the resources at the stage A and the stage R are idle) occurs in the pipeline following the branch instruction operation, and it takes nine cycles until the completion of the execution of the branch destination instruction.

Next, in FIG. 3B, the operation in the cycles 0 and 1 are similar to those in FIG. 3A. In the cycle 2, the branch establishment is predicted at the stage R, and the branch destination address calculated at the stage R is selected as a next fetch address at the stage I. The instruction of (the branch instruction+1) at the stage Q is cancelled. In the cycle 3, the branch is established based on a decision of the branch instruction, and a branch prediction hit is decided at the stage A. No instruction is necessary for the instruction continuing the branch destination instruction. In this case, it takes eight cycles until the completion of the execution of the branch destination instruction. As compared with the case in FIG. 3A, the execution of the instruction is completed one cycle earlier. This is the effect of the branch prediction.

Next, in FIG. 3C, the branch prediction status of the branch instruction before entering this loop is set as the “Strongly Not Taken” (SNT). A first branch instruction (1) is predicted as the branch non-establishment, and the branch is established at the stage A. Therefore, the pipeline operation up to the second branch instruction (2) is similar to that in FIG. 3A. In the cycle 5, the “Weakly Not Taken” (WNT) as the updated branch prediction status is written back to the branch prediction status memory unit 4.

On the other hand, the branch prediction status of the second branch instruction (2) is read out in the cycle 4. Therefore, the status before the updating of the branch prediction status of the first branch instruction (1) (the “Strongly Not Taken”: SNT) is used for the branch prediction. Accordingly, the pipeline operation from the second branch instruction (2) to the third branch instruction (3) is similar to that in FIG. 3A. Further, the updating of the branch prediction status of the second branch instruction (2) in the cycle 8 becomes the “Weakly Not Taken” (WNT) that is the same as the first branch instruction (1). Therefore, the branch prediction status shift is stagnant.

For the third branch instruction (3), the branch prediction status is read out in the cycle 7. In this case, the updating of the branch prediction status of the first branch instruction (1) has been completed. Therefore, the “Weakly Not Taken” (WNT) is output, and the branch non-establishment is predicted in the cycle 8. This similarly applies to the fourth branch instruction (4). Accordingly, the pipeline operation similar to that in FIG. 3A applies to the branch instruction (1) to the branch instruction (4).

For the fifth branch instruction (5), the branch prediction status is read out from the branch prediction status memory unit 4 in the cycle 13. Based on the updating of the branch prediction status of the branch instruction (3), the “Weakly Taken” (WT) is output. In other words, the branch prediction turns to the branch establishment prediction for the first time. Thereafter, the pipeline operation shown in FIG. 3B is repeated.

In the cycle 17, the updated value of the branch prediction status of the fifth branch instruction (5) becomes the “Strongly Taken” (ST). In the seventh branch instruction (7), the prediction status of the “Strongly Taken” (ST) can be read for the first time at the stage Q. In other words, it is necessary to execute five branch instructions from the prediction of the “Strongly Not Taken” (SNT) to the prediction of the “Strongly Taken” (ST). Thus, it takes 22 cycles up to the completion of the branch instruction of the seventh instruction.

As explained above, particularly the branch prediction status in the short program loop shifts in a delayed state without being synchronous with the actual branch operation. Therefore, the pipeline bubble following the branch operation increases, and this has increased the program execution time. In the above example, a one-instruction loop, which is rare in the actual program, has been explained. In the case of a super scalar processor for simultaneously fetching and executing a plurality of instructions in a different structure of the processor, the probability of the appearance of this loop increases. Thus, the reduction in the performance of the program as a whole cannot be disregarded.

As explained above, according to the conventional branch prediction apparatus for carrying out a branch prediction based on the past history of the branch result (that is, the branch prediction status), the updating of the branch prediction status used for the branch prediction has been carried out for only the memory unit that stores the branch prediction status. Therefore, the branch prediction status corresponding to the same branch instruction (succeeding branch instructions) on the pipeline of which branch prediction status has already been read from the branch prediction status memory unit has not been updated, and this has remained old. In other words, the branch prediction status has shifted in a delayed state without being synchronous with the actual branch operation. There is a high probability that the delay in the branch prediction status occurs in a short program loop in which the same branch instructions are executed at a close time interval. In this status, the pipeline bubble following the branch operation has increased, and, this has brought about the inconvenience of increasing the program execution time.

### SUMMARY OF THE INVENTION

The present invention has been made to solve the above problems of the conventional technique.

It is an object of the present invention to provide a branch prediction apparatus and a branch prediction method capable of carrying out a branch prediction using a branch prediction status always in the latest status, increasing the branch prediction efficiency, and decreasing the time for executing an instruction.

According to a branch prediction apparatus relating to the present invention, the shit (updating) of the branch prediction status of a branch instruction is bypassed as a branch prediction status that is used for a branch prediction of the same branch instruction that continues on the pipeline. The branch prediction of the same succeeding branch instructions is executed based on the branch prediction status that has always been updated to the latest status.

According to one aspect of the present invention, there is provided a pipeline processing apparatus for executing a branch prediction of a conditional branch instruction based on the history of results of branching, the pipeline processing apparatus comprising: a branch prediction status memory unit for storing a branch prediction status of a conditional branch instruction, the stored branch prediction status being read according to a current instruction fetch address; a branch prediction executing unit for predicting whether a branch condition of a conditional branch instruction is satisfied or non-satisfied based on the branch prediction status stored in the branch prediction status memory unit, and for instructing that a branch destination address is selected as the instruction fetch address when it has been predicted that the branch condition of the conditional branch instruction is satisfied; a branch prediction deciding unit for deciding whether a branch prediction executed by the branch prediction execution unit according to a result of a decision on the branch condition is correct or wrong at the time of the execution of the conditional branch instruction, and for instructing that an address of the instruction to be executed next to the conditional branch instruction is selected as the instruction fetch address when it has been decided that the branch prediction is wrong; a branch prediction status updating unit for updating the branch prediction status stored in the branch prediction status memory unit based on a result of a decision on the branch condition; a selector for selecting a latest branch prediction status updated by the branch prediction status updating unit, and for supplying the latest branch prediction status to the branch prediction execution unit; and a bypass controller for comparing a conditional branch instruction address at a preceding pipeline stage with an instruction address at a succeeding pipeline stage, and for controlling to supply the updated latest branch prediction status to the succeeding conditional branch instruction that is the same as the preceding conditional branch instruction when both addresses coincide with each other.

According to another aspect of the invention, there is provided a pipeline processing method of executing a branch prediction of a conditional branch instruction based on the history of results of branching, the method comprising the steps of: predicting whether a branch condition of a conditional branch instruction is satisfied or non-satisfied based on the stored branch prediction status, and instructing that a branch destination address is selected as an instruction fetch address when it has been predicted that the branch condition of the conditional branch instruction is satisfied; deciding whether a branch prediction executed at the branch prediction step according to a result of a decision on the branch condition is correct or wrong at the time of the execution of the conditional branch instruction, and instructing that an address of the instruction to be executed next to the conditional branch instruction is selected as the instruction fetch address when it has been decided that the branch prediction is wrong; updating the stored branch prediction status based on a result of a decision on the branch condition; selecting the updated latest branch prediction status, and bypass supplying always the latest branch prediction status to the succeeding conditional branch instruction; and comparing a conditional branch instruction address at a preceding pipeline stage with an instruction address at a succeeding pipeline stage, and supplying the updated latest branch prediction status to the succeeding conditional branch instruction that is the same as the preceding conditional branch instruction when both addresses coincide with each other.

Various further and more specific objects, features and advantages of the invention will appear from the description given below, taken in connection with the accompanying drawings illustrating by way of example a preferred embodiments of the invention.

### BRIEF DESCRIPTION OF THE DRAWINGS

FIG. 1 is a diagram showing a structure of a microprocessor equipped with a conventional branch prediction apparatus;

FIG. 2 is a diagram showing a status shift of a branch prediction algorithm according to a conventional practice and also according to an embodiment of the present invention;

FIGS. 3A, 3B and 3C are diagrams showing a pipeline operation of a microprocessor using a conventional branch prediction apparatus respectively;

FIG. 4 is a diagram showing a structure of a microprocessor equipped with a branch prediction apparatus according to an embodiment of the present invention;

FIGS. 5A, 5B and 5C are diagrams showing one example of a pipeline operation of a microprocessor according to the embodiment of the present invention shown in FIG. 4; and

FIG. 6 is a diagram showing another example of a program loop operation of a microprocessor according to the embodiment of the present invention shown in FIG. 4.

### DETAILED DESCRIPTION OF THE PREFERRED EMBODIMENTS

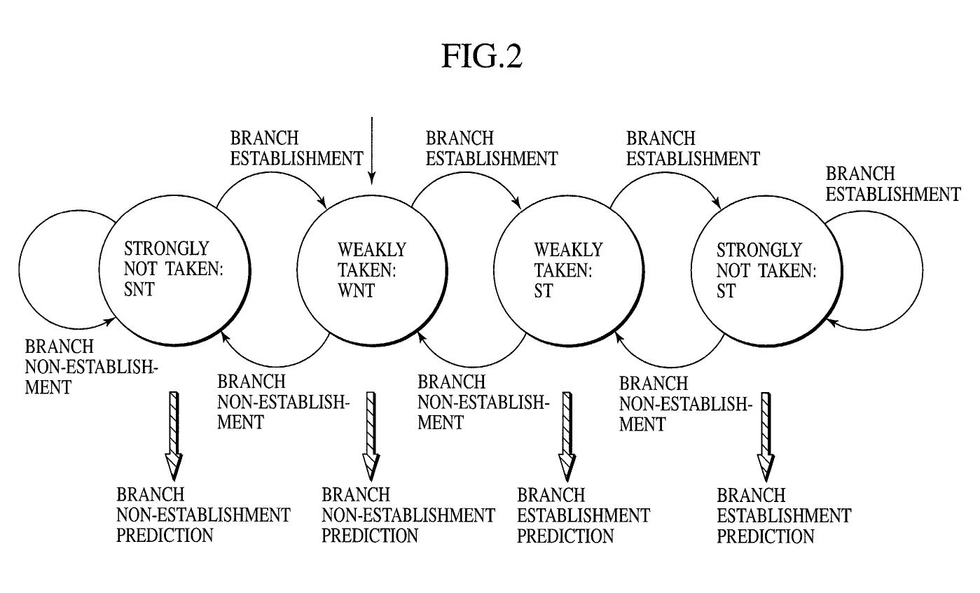

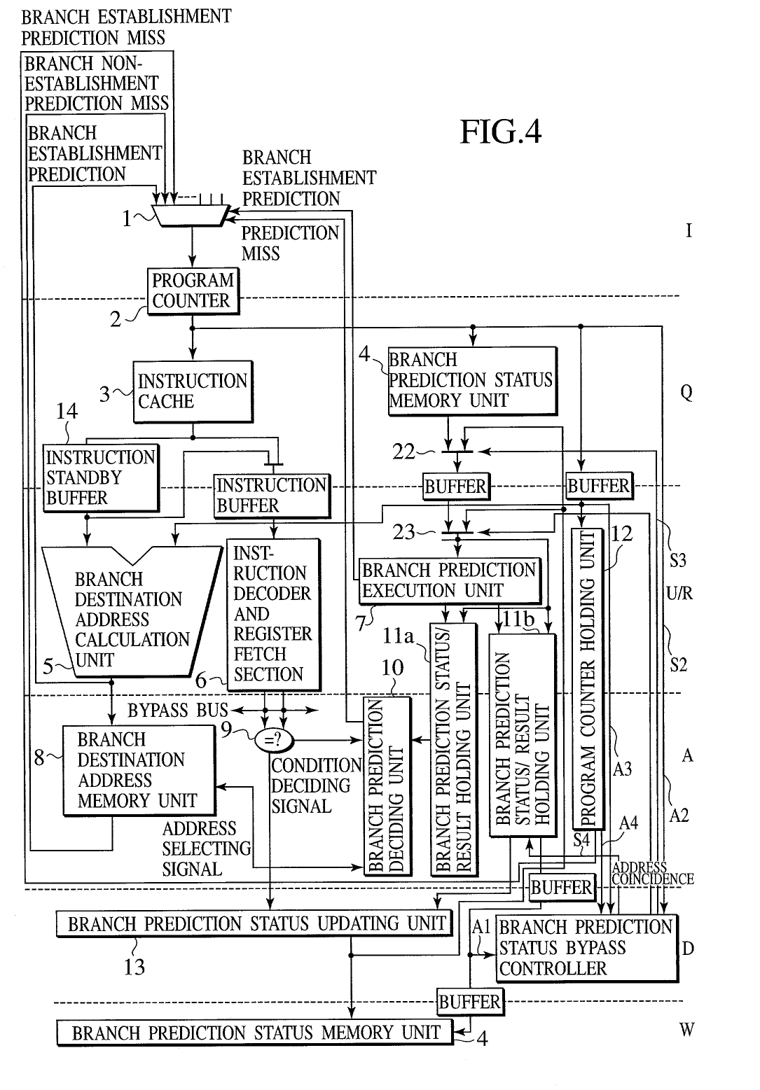

Hereinafter, a branch prediction apparatus and a microprocessor including this branch prediction apparatus relating to embodiments of the present invention will be explained in detail with reference to FIG. 2, FIG. 4 to FIG. 6.

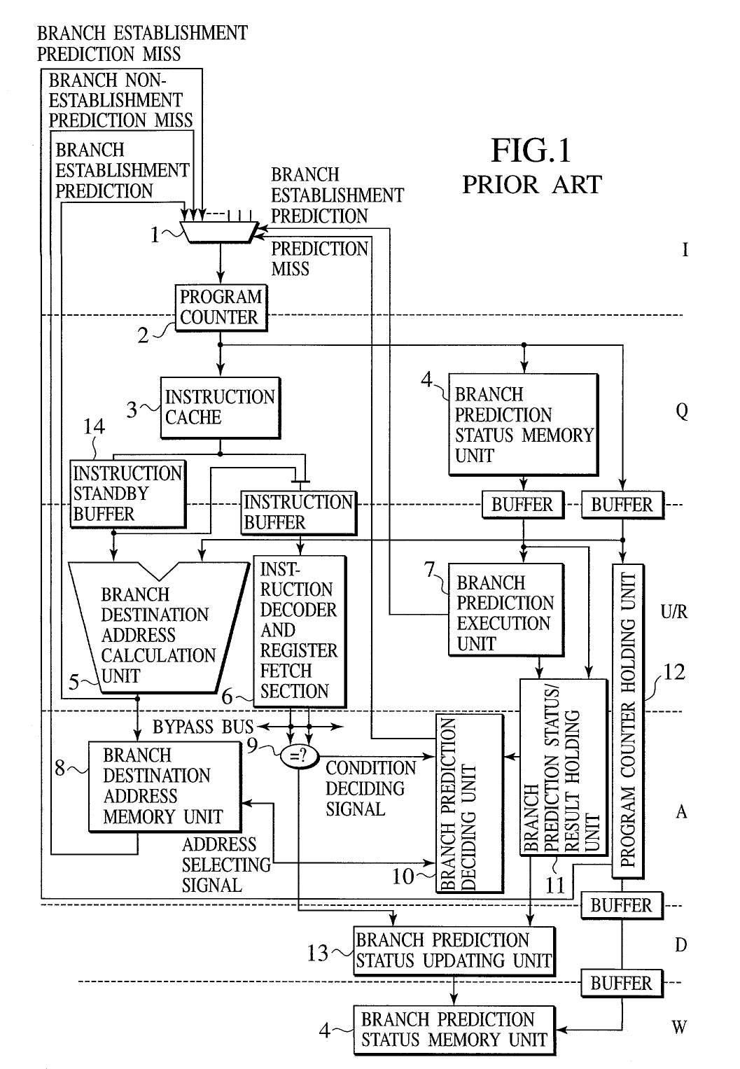

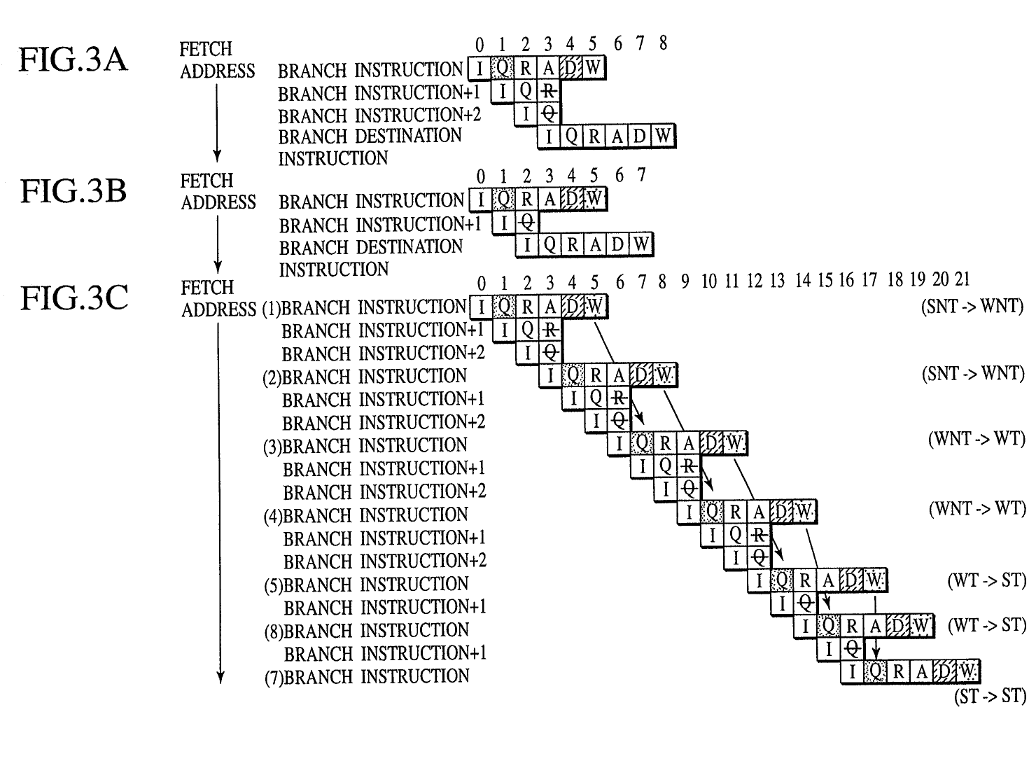

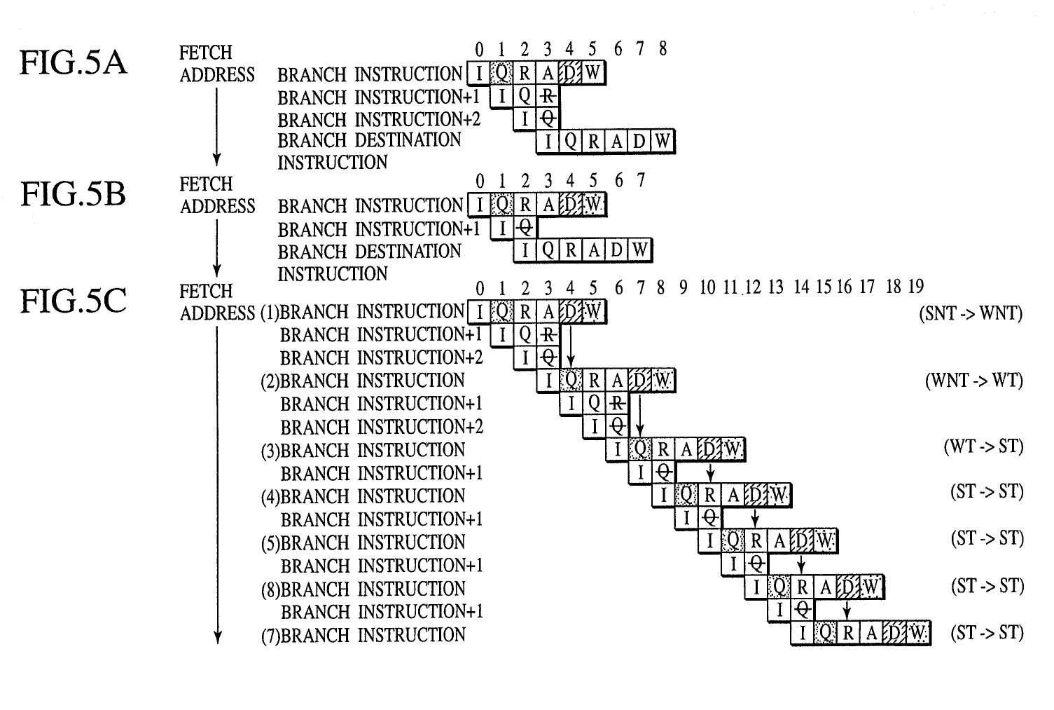

FIG. 4 is a diagram showing a structure of a microprocessor including a branch prediction apparatus according to an embodiment of the present invention. FIGS. 5A, 5B and 5C are diagrams showing a flow of a pipeline operation in the apparatus shown in FIG. 1. FIG. 5A shows an operation of the processor in a branch non-establishment prediction miss, or having no branch prediction function. FIG. 5B shows an operation of a branch establishment prediction hit. FIG. 5C shows one example of an operation of a program loop in which a branch destination instruction of a branch instruction is the branch instruction itself. FIGS. 5A, 5B and 5C correspond to FIGS. 3A, 3B and 3C respectively.

In the microprocessor according to the present embodiment shown in FIG. 4, the structures and operations of portions not directly relating to the branch prediction are the same as those of the conventional structures and operations shown in FIG. 1. In FIG. 4, those portions having the same structures are attached with identical reference numbers to those in FIG. 1, and their explanation will be omitted here. Further, in the branch prediction apparatus shown in FIG. 4, the branch prediction algorithm of the status shift used is the same as the conventional algorithm shown in FIG. 2. Differences of the branch prediction apparatus and the microprocessor according to the present embodiment from the conventional branch prediction apparatus and microprocessor shown in FIG. 1, and differences in operation due these differences will be explained below.

The branch prediction apparatus according to the present embodiment shown in FIG. 4 further comprises a branch prediction status bypass controller 21, compared with the conventional branch prediction apparatus shown in FIG. 1.

The branch prediction status bypass controller 21 selects an instruction address corresponding to a branch instruction at the stage A from the address stored in the program counter holding unit 12. The branch prediction status bypass controller 21 compares a branch instruction address (A1) sent to the stage D with an instruction address (A2) at the stage Q, or a branch instruction address (A3) at the branch prediction stage in the cycle next to the stage Q, or all instruction addresses (A4) at the stages U, R and A stored in the program counter holding unit 12, respectively. Then, the branch prediction status bypass controller 21 decides whether these addresses coincide with each other or not.

(1) First, when it has been detected that the branch instruction address (A1) coincides with an instruction address at a stage before the branch prediction stage, that is, the instruction address (A2) at the stage Q, the branch prediction status bypass controller 21 outputs selection signals S2 and S3 to the selector 22 and a selector 23, respectively. The selection signals S2 and S3 instruct that a new branch prediction status generated by the branch prediction status updating unit 13 is supplied to the branch prediction status execution unit 7. Thus, the latest branch prediction status updated by the branch prediction status updating unit 13 is selected by the selector 22 and the selector 23, and is supplied to the branch prediction execution unit 7. The new branch prediction status is used for the branch prediction at the branch prediction stage.

(2) Further, when it has been detected that the branch instruction address (A1) coincides with an instruction address in the cycle next to the stage Q, that is, the branch instruction address (A3) at the branch prediction stage, the branch prediction status bypass controller 21 outputs the selection signal S3 to the selector 23. The selection signal S3 is for instructing that a new branch prediction status generated by the branch prediction status updating unit 13 is supplied to the branch prediction status execution 7. Thus, the latest branch prediction status updated by the branch prediction status updating unit 13 is selected by the selector 23, and is supplied to the branch prediction execution unit 7. The new branch prediction status is used for the branch prediction at the branch prediction stage.

(3) On the other hand, when it has been detected that the branch instruction address (A1) coincides with an instruction address at a later stage, that is, when it has been detected that the branch instruction address (A1) coincides with any one of the instruction addresses (A4) at the stages U, R and A stored in the program counter holding unit 12, the branch prediction status stored in a branch prediction status/result holding unit 11b is replaced with the branch prediction status generated by the branch prediction status updating unit 13 in synch with the address of which coincidence has been detected.

In the present embodiment, two branch prediction status/result holding units 11a and 11b are provided as compared with the structure shown in FIG. 1. The branch prediction status/result holding unit 11a holds an original branch prediction status that has been used for the branch prediction of the branch instruction. On the other hand, the branch prediction status/result holding unit 11b holds a latest branch prediction status that has been updated after the branch decision.

In other words, an output of the branch prediction status/result holding unit 11a is supplied to the branch prediction status deciding unit 10, and is used for making a decision about hit/error of the branch prediction. Therefore, even when the branch prediction status of the preceding same branch instruction has been updated after the branch prediction stage, the branch prediction status held in the branch prediction status/result holding unit 11a is not updated. On the other hand, an output of the branch prediction status/result holding unit 11b is supplied to the branch prediction status updating unit 13, and this is used as an original data of the branch prediction status shift. Therefore, when the branch instruction that is the same as the branch instruction at the stage D has been detected at the stages U, R and A after the branch prediction stage, the branch prediction status is updated according to the instruction signal (S4) from the branch prediction status bypass controller 21.

Next, the pipeline operation for the branch prediction according to the present embodiment having the above-described structure will be explained next with reference to FIG. 5.

For comparing the pipeline operation with the conventional pipeline operation shown in FIG. 3, this operation will be explained based on the same instruction sequence. FIGS. 5A and 5B show the operation relating to the branch prediction hit/miss of a single branch instruction, and this operation is the same as the conventional operation shown in FIGS. 3A and 3B.

On the other hand, there is a difference in the operation example of one branch instruction loop shown in FIG. 5C from the conventional operation example shown in FIG. 3C. First, assume that the branch prediction status of the branch instruction before entering this loop is set to the “Strongly Not Taken” (SNT). The operation will be explained below following the cycles. In the following explanation, the “branch instruction” means the same branch instruction in all cases.

In the cycle 0, the address of the first branch instruction (1) is selected as a fetch address.

In the cycle 1, the branch instruction (1) is fetched from the instruction cache 3 at the stage Q. At the same time, a corresponding branch prediction status is read from the branch prediction status memory unit 4. Further, at the stage I, the address of (the branch instruction+1) is selected as a fetch address.

In the cycle 2, the branch prediction execution unit 7 predicts the branch instruction (1) as branch non-establishment at the stage R. Therefore, the address of (the branch instruction+2) is selected as a fetch address at the stage I.

In the cycle 3, the branch prediction deciding unit 10 decides the branch instruction (1) as branch establishment at the stage A. Because of a branch prediction miss, the address of the branch instruction (2) that is a branch destination of the branch instruction is selected as a fetch address at the stage I. The instructions at the stage Q and the stage R are cancelled.

In the cycle 4, the branch prediction status updating unit 13 updates the branch prediction status of the branch instruction (1) to the “Weakly Not Taken” (WNT) at the stage D. Further, the branch prediction status bypass controller 21 compares the program counter value A1 at the stage D with the program counter values A2, A3 and A4 at the stages Q, R and A, respectively. The branch prediction status bypass controller 21 controls the coincided selector 22 at the stage Q to discard data read from the branch prediction status memory unit 4 and to select data from the branch prediction status updating unit 13 based on the control signal S2. Thus, the bypassing of the branch prediction status to the branch instruction (2) at the stage Q is realized.

In the cycle 5, the “Weakly Not Taken” (WNT) is written back to the branch prediction status memory unit 4 at the stage W. The branch instruction (2) is predicted as the “Weakly Not Taken” (WNT) at the stage R.

In the cycle 6, the operation same as that in the cycle 3 is carried out.

In the cycle 7, the branch prediction status updating unit 13 updates the branch prediction status of the branch instruction (2) to the “Weakly Taken” (WT) at the stage D. In the same manner as that of the bypassing of the branch prediction status in the cycle 4, the branch prediction status bypass controller 21 controls the selector 22 at the stage Q to discard data read from the branch prediction status memory unit 4 and to select data from the branch prediction status updating unit 13 based on the control signal S2. Thus, the bypassing of the branch prediction status to the branch instruction (3) at the stage Q is generated.

In the cycle 8, the “Weakly Taken” (WT) is written back to the branch prediction status memory unit 4 at the stage W. The branch instruction (3) is predicted as the “Weakly Taken” (WT) at the stage R. The address of the branch instruction (4) that is branch destination of the branch instruction (3) is selected as a fetch address at the stage I.

In the cycle 9, the branch instruction (3) is decided as branch establishment at the stage A. Because of a branch prediction hit, the address of (the branch instruction+1) is selected as a fetch address at the stage I. The branch prediction status of the branch instruction (4) is read out as the “Weakly Taken” (WT) from the branch prediction status memory unit 4 at the stage Q.

In the cycle 10, the branch prediction status updating unit 13 updates the branch prediction status of the (3) to the “Strongly Taken” (ST) at the stage D. Further, the branch prediction status bypass controller 21 compares the program counter value A1 at the stage D with the program counter values A2, A3 and A4 at the stages Q, R and A, respectively. The branch prediction status bypass controller 21 controls the coincided selector 23 at the stage R to select data from the branch prediction status updating unit 13 based on the control signal S3. Thus, the bypassing of the branch prediction status to the branch instruction (4) at the stage R is realized.

Thereafter, the updating of the similarly appearing branch instruction to the “Strongly Taken” (ST), and the bypassing of the “Strongly Taken” (ST) from the stage D to the stage R are repeated.

As explained above, the shift of the branch prediction status is carried out in synch with the execution of the branch instruction. As a result, it becomes possible to predict the “Strongly Taken” seven cycles earlier than the conventional operation shown in FIG. 3. It takes 20 cycles up to the completion of the execution of the seventh branch instruction (7). As compared with the conventional operation, the operation of the present embodiment can be completed two cycles earlier.

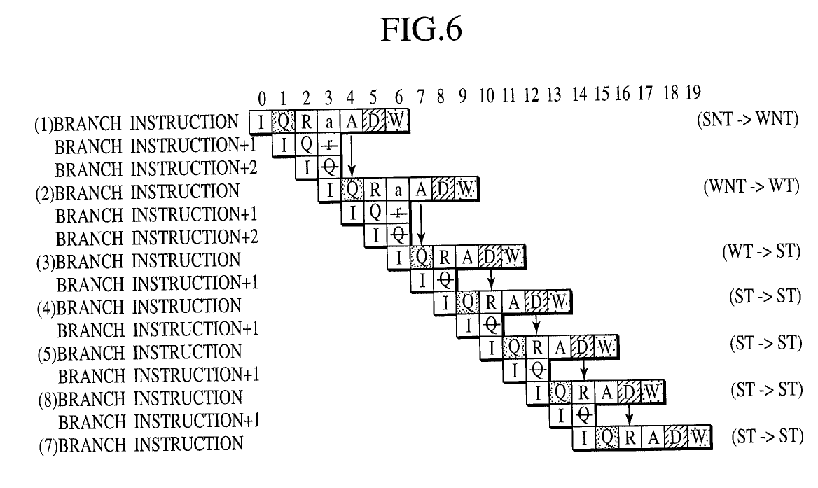

FIG. 6 shows another example of a pipeline operation in the branch prediction according to the present embodiment.

In the operation example shown in FIG. 6, the first branch instruction (1) stalls in the pipeline for certain reason at the stage A in the cycle 3. In the explanation of FIG. 6 and after, the pipeline stall is expressed in small letters.

Up to the cycle 2, the operation is the same as that in FIG. 5C.

In the cycle 3, the first branch instruction (1) stalls at the stage A, and it is assumed that the branch condition has been firm. At the stage I, based on the decision of the branch condition of the branch instruction (1) at the stage A, branch establishment, that is, a branch prediction miss is decided. Then, the address of the branch instruction (2) that is a correct branch destination is selected as an instruction fetch address. The instructions at the stage Q and the stage R are cancelled because of the branch instruction error.

In the cycle 4, the branch prediction status of the branch instruction (2) is read out as the “Strongly Not Taken” (SNT) from the branch prediction status memory unit 4.

In the cycle 5, the branch prediction status updating unit 13 updates the branch prediction status of the branch instruction (1) to the “Weakly Not Taken” (WNT) at the stage D. Further, the branch prediction status bypass controller 21 compares the program counter value A1 at the stage D with the program counter values A2, A3 and A4 at the stages Q, R and A, respectively. The branch prediction status bypass controller 21 controls the coincided selector 23 at the stage R to select the data from the branch prediction status updating unit 13 based on the control signal S3. Thus, the bypassing of the branch prediction status to the branch instruction (2) at the stage R is realized.

In the cycle 6, the operation is similar to that in the cycle 3.

In the cycle 7, the branch prediction status of the branch instruction (3) is read out as the “Weakly Not Taken” (WNT) from the branch prediction status memory unit 4.

In the cycle 8, the branch prediction status updating unit 13 updates the branch prediction status of the branch instruction (2) to the “Weakly Taken” (WT) at the stage D. The bypassing of the branch prediction status to the branch instruction (3) at the stage R is generated in a similar manner to that of the operation in the cycle 5. At the same time, the branch prediction execution unit 7 predicts the branch establishment using the bypassed branch prediction status “Weakly Taken” (WT). Based on this, the address of the branch instruction (4) that is the branch destination address is selected as an instruction fetch address at the stage I.

In the subsequent cycles, the same operation as that shown in FIG. 5C is carried out.

As explained above, according to the present embodiment, the shit (updating) of the branch prediction status of a branch instruction is bypassed as a branch prediction status of the same branch instruction on the pipeline. The branch prediction status used for the branch prediction and the branch prediction status shift is always updated to the latest status. Therefore, it is possible to improve the branch prediction efficiency and to decrease the program execution time.

Particularly, in the case of a super scalar processor capable of simultaneously executing a plurality of instructions, a similar pipeline operation is carried out in the program loop consisting of a plurality of instructions. As a result, the branch prediction efficiency improves further. It is also possible to obtain an extremely large effect in the processor that employs what is called a super pipeline structure having a large number of stages from the instruction fetch to the decision on the branch condition.

Further, in the above embodiment, additional information such as the access history and the fetch address attributes of the instruction cache 3 and the branch prediction status memory unit 4 at the stage Q may be used for the branch prediction status bypass controller 21 to detect coincidence, depending on the structure of the instruction cache 3.

For example, when the processor is equipped with an instruction cache of the set-associative type, the processor can be structured to hold information including a set number that has hit in the instruction fetching, a cache reading index, and a flag for showing whether an instruction has been fetched using an instruction cache or not, in synch with the branch prediction status stored in the branch prediction status/result holding unit. These pieces of information may be used for the branch prediction status bypass controller 21 to detect coincidence. Based on this structure, it is possible to decrease the number of bits that are necessary for the detection of coincidence. Therefore, it is possible to decrease the hardware and to decrease the time required for detecting coincidence.

In summary, according to the present invention, the shit of the branch prediction status of a branch instruction is bypassed as a branch prediction status of the same branch instruction on the pipeline. The branch prediction status used for the branch prediction and the branch prediction status shift is always updated to the latest status. Therefore, it is possible to improve the branch prediction efficiency and to decrease the program execution time.

Various modifications will become possible for those skilled in the art after receiving the teachings of the present disclosure without departing from the scope thereof. It is intended, therefore, that all matter contained in the foregoing description and in the drawing shall be interpreted as illustrative only not as limitative of the invention.

What is claimed is:

1. A pipeline processing apparatus for executing a branch prediction of a conditional branch instruction based on the history of results of branching, the pipeline processing apparatus comprising:
a branch prediction status memory unit for storing a branch prediction status of a conditional branch instruction, the stored branch prediction status being read according to a current instruction fetch address;
a branch prediction execution unit for predicting whether a branch condition of a conditional branch instruction is satisfied or non-satisfied based on the branch prediction status stored in the branch prediction status memory unit, and for instructing that a branch destination address is selected as the instruction fetch address when it has been predicted that the branch condition of the conditional branch instruction is satisfied;
a branch prediction deciding unit for deciding whether a branch prediction executed by the branch prediction execution unit according to a result of a decision on the branch condition is correct or wrong at the time of the execution of the conditional branch instruction, and for instructing that an address of the instruction to be executed next to the conditional branch instruction is selected as the instruction fetch address when it has been decided that the branch prediction is wrong;
a branch prediction status updating unit for updating the branch prediction status stored in the branch prediction status memory unit based on a result of a decision on the branch condition;
a selector for selecting a latest branch prediction status updated by the branch prediction status updating unit, and for supplying the latest branch prediction status to the branch prediction execution unit; and
a bypass controller for comparing a conditional branch instruction address at a preceding pipeline stage with an instruction address at a succeeding pipeline stage, and for controlling to supply the updated latest branch prediction status to the succeeding conditional branch instruction that is the same as the preceding conditional branch instruction when both addresses coincide with each other.

2. The pipeline processing apparatus according to claim 1, further comprising:
a first branch prediction status holding unit for holding the branch prediction status used for the branch prediction by the branch prediction execution unit and a result of a branch prediction predicted by the branch prediction execution unit, and f or supplying to the branch prediction deciding unit a result of a branch prediction corresponding to a conditional branch instruction for which the branch condition is decided at a predetermined pipeline stage; and
a second branch prediction status holding unit f or holding the branch prediction status used for the branch prediction by the branch prediction execution unit and a result of a branch prediction predicted by the branch prediction execution unit, for supplying to the branch prediction status updating unit the branch prediction status corresponding to the conditional branch instruction for which a branch establishment or a branch non-establishment has become firm at a predetermined pipeline stage, and for updating the held branch prediction status to the branch prediction status updated by the branch prediction status updating unit based on a control signal from the bypass controller.

3. The pipeline processing apparatus according to claim 1, wherein
the bypass controller compares a current conditional branch instruction address stored in the branch prediction status memory unit with a succeeding instruction address corresponding to each of a plurality of predetermined pipeline stages, and when the conditional branch instruction corresponding to an instruction address of which coincidence has been detected exists at a pipeline stage before the stage of executing the branch prediction, the bypass controller outputs to the selector a first control signal for instructing that the branch prediction status updated by the branch prediction status updating unit is supplied to the branch prediction execution unit.

4. The pipeline processing apparatus according to claim 2, wherein
the bypass controller compares a current conditional branch instruction address stored in the branch prediction status memory unit with a succeeding instruction address corresponding to each of a plurality of predetermined pipeline stages, and when the conditional branch instruction corresponding to an instruction address of which coincidence has been detected exists at a pipeline stage after the stage of executing the branch prediction, the bypass controller outputs to the second branch prediction status holding unit a second control signal for instructing that the branch prediction status held by the second branch prediction status holding unit is updated to the branch prediction status updated by the branch prediction execution unit.

5. The pipeline processing apparatus according to claim 1, further comprising:
a write back address holding unit for holding a write back address, at which the branch prediction status updated by the branch prediction status updating unit is written back to the branch prediction status memory unit, corresponding to the conditional branch instruction on the pipeline.

6. The pipeline processing apparatus according to claim 5, wherein
said branch prediction status memory unit is a set-associative type memory unit, and the write back address held by the write back address holding unit includes a reading address from the branch prediction status memory unit, a set number selected by the reading, and a flag that indicates whether an instruction fetch has been carried out from an instruction cache memory or not.

7. A pipeline processing method of executing a branch prediction of a conditional branch instruction based on the history of results of branching, the method comprising the steps of:
predicting whether a branch condition of a conditional branch instruction is satisfied or non-satisfied based on the stored branch prediction status, and instructing that a branch destination address is selected as an instruction fetch address when it has been predicted that the branch condition of the conditional branch instruction is satisfied;
deciding whether a branch prediction executed at the branch prediction step according to a result of a decision on the branch condition is correct or wrong at the time of the execution of the conditional branch instruction, and instructing that an address of the instruction to be executed next to the conditional branch instruction is selected as the instruction fetch address when it has been decided that the branch prediction is wrong;
updating the stored branch prediction status based on a result of a decision on the branch condition;
selecting the updated latest branch prediction status, and bypass supplying always the latest branch prediction status to the succeeding conditional branch instruction; and
comparing a conditional branch instruction address at a preceding pipeline stage with an instruction address at a succeeding pipeline stage, and supplying the updated latest branch prediction status to the succeeding conditional branch instruction that is the same as the preceding conditional branch instruction when both addresses coincide with each other.

8. The pipeline processing method according to claim 7, further comprising the steps of:
holding the branch prediction status used for the branch prediction and a predicted result of a branch prediction in a first holding unit, and supplying to the branch prediction deciding step a result of a branch prediction corresponding to a conditional branch instruction for which the branch condition is decided at a predetermined pipeline stage; and
holding the branch prediction status used for the branch prediction and a predicted result of a branch prediction in a second holding unit, supplying to the branch prediction status updating step the branch prediction status corresponding to the conditional branch instruction for which a branch establishment or a branch non-establishment has become firm at a predetermined pipeline stage, and updating the held branch prediction status to the branch prediction status updated at the branch prediction status updating step based on a control signal at the branch prediction status supplying step.

9. The pipeline processing method according to claim 7, wherein
in the branch prediction status supplying step, a stored current conditional branch instruction address is compared with a succeeding instruction address corresponding to each of a plurality of predetermined pipeline stages, and when the conditional branch instruction corresponding to an instruction address of which coincidence has been detected exists at a pipeline stage before the stage of executing the branch prediction, a first control signal for instructing that the branch prediction status updated at the branch prediction status updating step is supplied to the branch prediction executing step is output to a selector.

10. The pipeline processing method according to claim 8, wherein
in the branch prediction status updating step, a stored current condition branch instruction address is compared with a succeeding instruction address corresponding to each of a plurality of predetermined pipeline stages, and when the conditional branch instruction corresponding to an instruction address of which coincidence has been detected exists at a pipeline stage after the stage of executing the branch prediction, a second control signal for instructing that the branch prediction status held at the branch prediction status holding step is updated to the branch prediction status updated at the branch prediction status updating step is output to the second holding unit.

11. The pipeline processing method according to claim 7, further comprising the steps of:
holding a write back address at which the branch prediction status updated at the branch prediction status updating step is written back to the branch prediction status memory step, corresponding to the conditional branch instruction on the pipeline.
